(19) United States
(12) Patent Application Publication
(10) Pub. No.: US 2004/0063498 A1
(43) Pub. Date: Apr. 1, 2004

(54) System and method for flexibly implementing a wireless gaming network

(75) Inventors: Mark E. Oakes, San Jose, CA (US); Ted M. Dunn, Los Gatos, CA (US)

Correspondence Address: Gregory J. Koerner, SIMON & KOERNER LLP, Suite B, 10052 Pasadena Avenue, Cupertino, CA, 95014, US

(73) Assignees: Sony Corporation; Sony Electronics Inc.

(21) Appl. No.: 10/261,261

(22) Filed: Sep. 30, 2002

(51) Int. Cl. G06F 19/00

(52) U.S. Cl. 463/42

(57) ABSTRACT

A system and method for flexibly implementing a wireless gaming network of compatible portable units may include individual game applications that allow each respective portable unit to function in either a server mode as a server unit that manages a particular gaming event, or in a client mode as a client unit that participates in the gaming event. The compatible portable units may include one or more client units configured to utilize corresponding game applications in the client mode to participate in the gaming event. The compatible portable units may also include a selectable server unit configured to utilize a game application in the server mode for managing the gaming event. The server unit may also include a security module that separately controls access by the various client units for participating in the gaming event.

### BACKGROUND SECTION

1. Field of the Invention

This invention relates generally to techniques for implementing electronic gaming systems, and relates more particularly to a system and method for flexibly implementing a wireless gaming network.

2. Description of the Background Art

Developing flexible methods for implementing electronic gaming systems is a significant consideration for designers and manufacturers of contemporary electronic entertainment systems. However, flexibly implementing electronic gaming systems may create substantial challenges for system designers. For example, enhanced demands for increased system functionality and performance may require more system processing power and require additional hardware resources. An increase in processing or hardware requirements may also result in a corresponding detrimental economic impact due to increased production costs and operational inefficiencies.

Furthermore, enhanced system capability to perform various advanced operations may provide additional benefits to a system user, but may also place increased demands on the control and management of various system components. For example, an enhanced electronic gaming system that flexibly supports video and audio content may benefit from an efficient implementation because of the large amount and complexity of the digital data involved.

Due to growing demands on system resources and substantially increasing data magnitudes, it is apparent that developing new techniques for flexibly implementing electronic gaming systems is a matter of concern for related electronic technologies. Therefore, for all the foregoing reasons, developing flexible systems for implementing electronic gaming systems remains a significant consideration for designers, manufacturers, and users of contemporary electronic gaming systems.

### SUMMARY

In accordance with the present invention, a system and method are disclosed for flexibly implementing a wireless gaming network by utilizing compatible portable units. In accordance with one embodiment of the present invention, system users or other appropriate entities may initially perform a configuration procedure for setting up corresponding portable units by utilizing any appropriate techniques. For example, in certain embodiments, the foregoing configuration procedure may specific various parameters and operating characteristics for operating the portable units in a server mode as a server unit, and/or in a client mode as a client unit.

The system users or other appropriate entities may then decide whether to place the respective portable units into the server mode or into the client mode. If server mode is selected, then the system user or other appropriate entity may preferably instruct the corresponding portable unit to enter server mode as the server unit for a particular gaming event by utilizing any effective means such as a game controller device. Then, the system user or other appropriate entity may select a particular game module from a game application, and a CPU of the server unit may preferably begin to run the game module by executing corresponding software instructions.

Next, a security module from the server unit may preferably begin to allow one or more logins from corresponding potential game participants or clients. In accordance with the present invention, the system user of the server unit or another appropriate entity may preferably approve or deny respective login attempts from the potential participants. The security module may preferably determine whether a pre-determined maximum number of players corresponding to the total number of approved client logins has been reached.

After the designated number of game participants has been reached, then the various system users may participate in the chosen gaming event by utilizing corresponding portable units. In accordance with the present invention, any of the portable units may advantageously be designated as a new server unit at any time during or after the gaming event. For example, a current server owner/controller of a current server unit may wish to cease participating as the server owner/controller of a particular gaming event. The system users or other appropriate entities may then designate another portable unit as a new server unit to thereby resume selected gaming events.

In the client mode, various potential client units may preferably perform a server search procedure to locate a server unit that is controlling a corresponding gaming event. The foregoing server search procedure may be performed in any effective manner. For example, the client units may wirelessly detect server game communications from the server unit, and may then responsively initiate a client login procedure by transmitting game access requests for logging into the server unit.

If the client login procedure has been successfully completed, then the system users of the respective client units may advantageously participate in the particular gaming event. At some point, the various participating portable units may preferably determine that the current game is finished, and the system users or other appropriate entities may again select and run the same or a different game module from the game application, in accordance with the present invention. The present invention therefore provides an improved system and method for flexibly implementing a wireless gaming network.

### BRIEF DESCRIPTION OF THE DRAWINGS

FIG. 1 is a block diagram of an electronic network, in accordance with one embodiment of the present invention;

FIG. 2 is a block diagram for one embodiment of a portable unit from FIG. 1, in accordance with the present invention;

FIG. 3 is a block diagram for one embodiment of a receive channel from the communications manager of FIG. 2, in accordance with the present invention;

FIG. 4 is a block diagram for one embodiment of a transmit channel from the communications manager of FIG. 2, in accordance with the present invention;

FIG. 5 is a block diagram for one embodiment of the memory of FIGS. 3 and 4, in accordance with the present invention;

FIG. 6 is a block diagram for illustrating a game application with a server mode and a client mode, in accordance with one embodiment of the present invention;

FIG. 7 is a flowchart of method steps for utilizing a portable server unit in an electronic gaming network, in accordance with one embodiment of the present invention; and

FIG. 8 is a flowchart of method steps for utilizing a portable client unit in an electronic gaming network, in accordance with one embodiment of the present invention.

### DETAILED DESCRIPTION

The present invention relates to an improvement in electronic gaming techniques. The following description is presented to enable one of ordinary skill in the art to make and use the invention, and is provided in the context of a patent application and its requirements. Various modifications to the disclosed embodiments will be readily apparent to those skilled in the art, and the generic principles herein may be applied to other embodiments. Thus, the present invention is not intended to be limited to the embodiments shown, but is to be accorded the widest scope consistent with the principles and features described herein.

The present invention is described herein as a system and method for flexibly implementing a wireless gaming network of compatible portable units, and may include individual game applications that allow each respective portable unit to function in either a server mode as a server unit that manages a particular gaming event, or in a client mode as a client unit that participates in the gaming event.

The compatible portable units may include one or more client units configured to utilize corresponding game applications in the client mode to participate in the gaming event. The compatible portable units may also include a selectable server unit configured to utilize a game application in the server mode for managing the gaming event. The server unit may advantageously include a security module that separately controls access of various potential client units for participating in the particular gaming event.

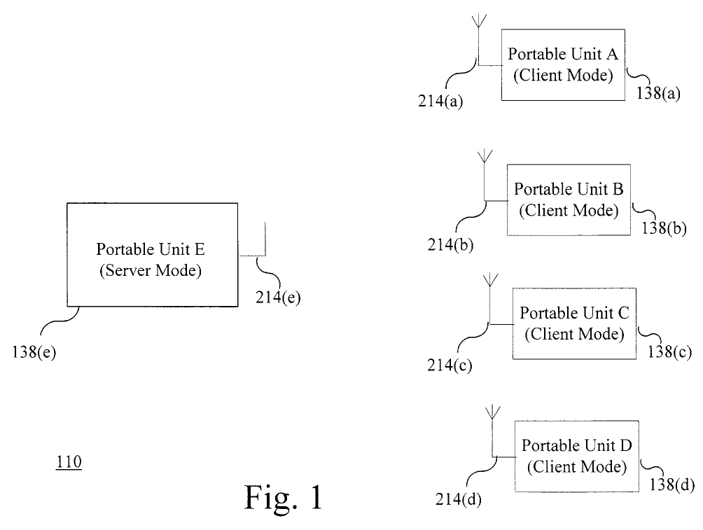

Referring now to FIG. 1, a block diagram of an electronic network 110 is shown, in accordance with one embodiment of the present invention. In the FIG. 1 embodiment, electronic network 110 may preferably include, but is not limited to, a portable unit E 138(e) that is functioning in a server mode, and portable units 138(a), 138(b), 138(c), and 138(d) that are each functioning in a client mode. A portable unit 138 that is functioning in a server mode may also be referred to herein as a server unit 138(e). Similarly, a portable unit 138 that is functioning in a client mode may also be referred to herein as a client unit 138(a). In addition, in certain embodiments, electronic network 110 may alternately be referred to herein as a gaming network.

In alternate embodiments, electronic network 110 may readily be implemented using various components and configurations in addition to, or instead of, those discussed in conjunction with the FIG. 1 embodiment. For example, although the FIG. 1 embodiment is shown with five portable units 138(a) through 138(e), electronic network 110 may readily include any number of portable units 138.

In the FIG. 1 embodiment, a portable unit 138 in the server mode (server unit 138(e)) may preferably be implemented as any type of electronic device that is configured to support and manage various functionalities for supporting gaming activities in electronic network 110. For example, in the FIG. 1 embodiment, server unit 138(e) may preferably provide a video signal and an audio signal from a game application to client units 138(a), 138(b), 138(c), and 138(d). Server unit 138(e) may also receive other input signals via a separate input (not shown). For example, in certain embodiments, other input signals on may include a cable television input, a television broadcasting receiver signal, or an Internet signal.

In the FIG. 1 embodiment, server unit 138(e) may preferably process the video signal and the audio signal to produce an audio/video (A/V) bitstream. Server unit 138(e) may then wirelessly transmit the A/V bitstream to client units 138(a) through 138(d) via antenna 214(e). Portable client units 138(a) through 138(d) may then responsively receive the A/V bitstream, and may display the corresponding game programming on portable displays (not shown) coupled to portable units 138(a) through 138(d). In addition, in the FIG. 1 embodiment, portable client units 138(a-d) may send various types of game control information back to server unit 138(e), which may responsively provide the game control information to the game application.

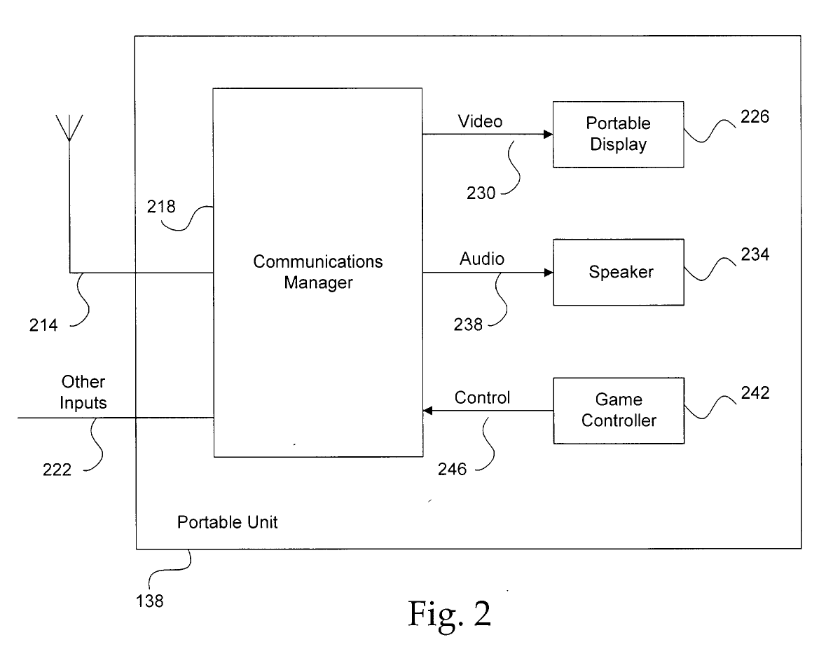

In certain embodiments of the present invention, a system user may utilize server unit 138(e) to simultaneously participate in a gaming event while server unit 138(e) concurrently operates in the server mode. In addition, in certain embodiments, game displays may be generated by each portable unit 138 individually, and the only data moved between the client devices and the server device would be either player content, e.g. what cards in the hand, or player position, e.g. in a multiplayer racing game. The implementation and utilization of the FIG. 1 electronic network 110 is further discussed below in conjunction with FIGS. 2 through 8.

Referring now to FIG. 2, a block diagram for one embodiment of a FIG. 1 portable unit 138 is shown, in accordance with the present invention. In the FIG. 2 embodiment, portable unit 138 in either server mode or client mode may preferably include, but is not limited to, a communication manager 218, a portable display 226, a speaker device 234, and a game controller 242. In alternate embodiments, portable unit 138 may readily be implemented using various components and configurations in addition to, or instead of, those discussed in conjunction with the FIG. 2 embodiment. As noted above, in certain embodiments, both server unit 138(e) and client units 138(a-d) of FIG. 1 may be implemented according to the FIG. 2 embodiment of portable unit 138.

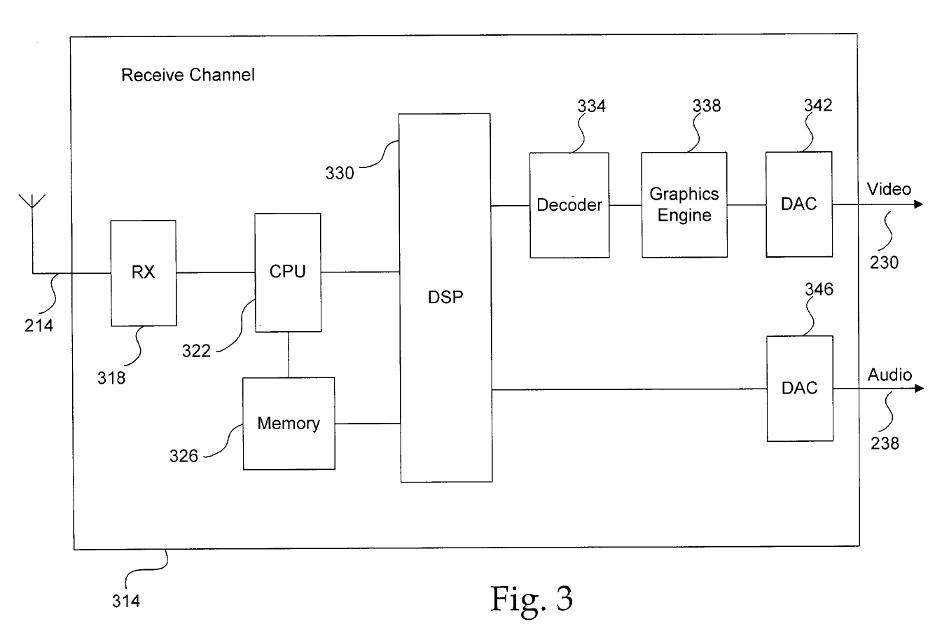

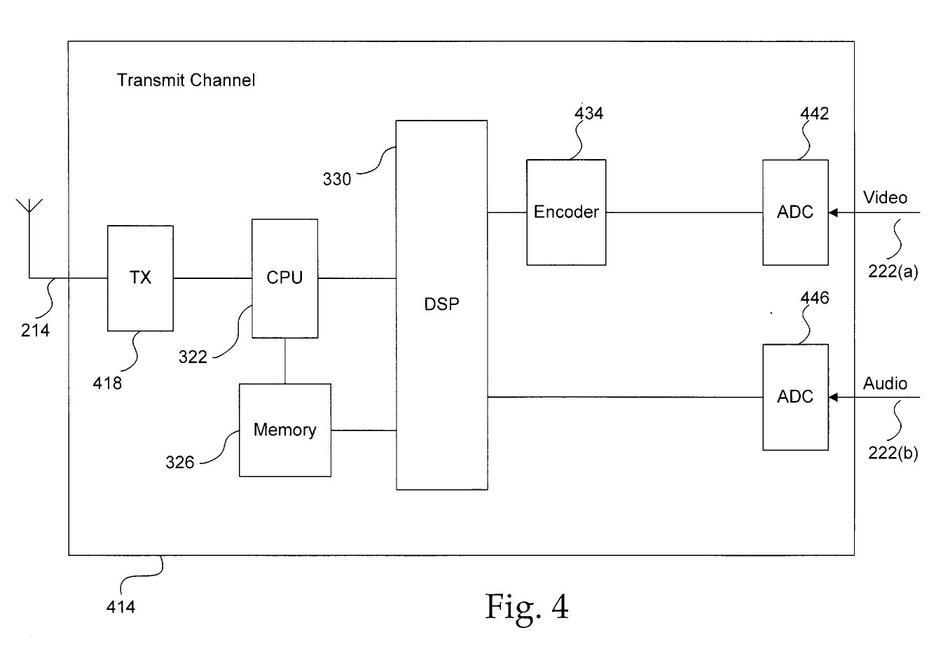

In the FIG. 2 embodiment, communications manager 218 may preferably include a transmit channel for transmitting information to other portable units 138. Communication manager 218 may also include a receive channel for receiving information from other portable units 138. One embodiment for implementing the foregoing transmit channel is discussed below in conjunction with FIG. 4. Similarly, one embodiment for implementing the foregoing receive channel is discussed below in conjunction with FIG. 3.

In the FIG. 2 embodiment, communications manager 218 may preferably receive an A/V bitstream from another portable unit 138 via antenna 214. Communications manager 218 may then preferably process the A/V bitstream and provide an appropriate video signal for display on portable display 226 via path 230. In the FIG. 2 embodiment, portable display 226 may be implemented by utilizing any effective technology, including, but not limited to, a liquid-crystal diode (LCD) screen or a cathode-ray tube (CRT) screen. Communications manager 218 may also preferably provide an appropriate audio signal via path 238 for reproduction by speaker device 234. In the FIG. 2 embodiment, speaker device 234 may be implemented by utilizing any effective technology, including, but not limited to, an audio power amplifier and a loudspeaker assembly.

In the FIG. 2 embodiment, game controller 242 may be implemented as any effective means for interacting with portable unit 138 to thereby participate a particular game or other interactive event. Game controller 242 may preferably provide control signals to communications manager 218 via path 246. Communications manager 218 may responsively transmit the foregoing control signals to the game application on server unit 138(e). In addition, communications manager 218 may similarly receive other input signals via path 222. For example, communications manager 218 may receive input signals from data sources that include, but are not limited to, an electronic camera device, an electronic keypad, a memory stick device, an electronic network, or a computer device. In certain embodiments, communications manager 218 may then responsively transmit the foregoing other input signals to various other portable units 138. The implementation and utilization of portable units 138 in either a server mode or a client mode are further discussed below in conjunction with FIGS. 3 through 8.

Referring now to FIG. 3, a block diagram for one embodiment of a receive channel 314 from the FIG. 2 communications manager 218 is shown, in accordance with the present invention. In the FIG. 3 embodiment, receive channel 314 may preferably include, but is not limited to, an antenna 214, a receiver (RX) 318, a central processing unit (CPU) 322, a memory 326, a digital signal processor (DSP) 330, a decoder 334, a graphics engine 338, a video digital-to-analog converter (DAC) 342, and an audio digital-to-analog converter (DAC) 346.

In alternate embodiments, receive channel 314 may readily be implemented using various components and configurations in addition to, or instead of, those discussed in conjunction with the FIG. 3 embodiment. For example, in certain embodiments receive channel 314 may be implemented without decoder 334.

In the FIG. 3 embodiment, a receiver (RX) 318 of receive channel 314 may preferably receive a radio-frequency transmission of an audio/video (A/V) bitstream from another portable unit 138 via antenna 214. Receiver 318 may preferably be implemented in any effective manner. For example, in certain embodiments, receiver 318 may preferably downconvert the A/V bitstream to a baseband frequency, and may then preferably provide the downconverted bitstream to CPU 322.

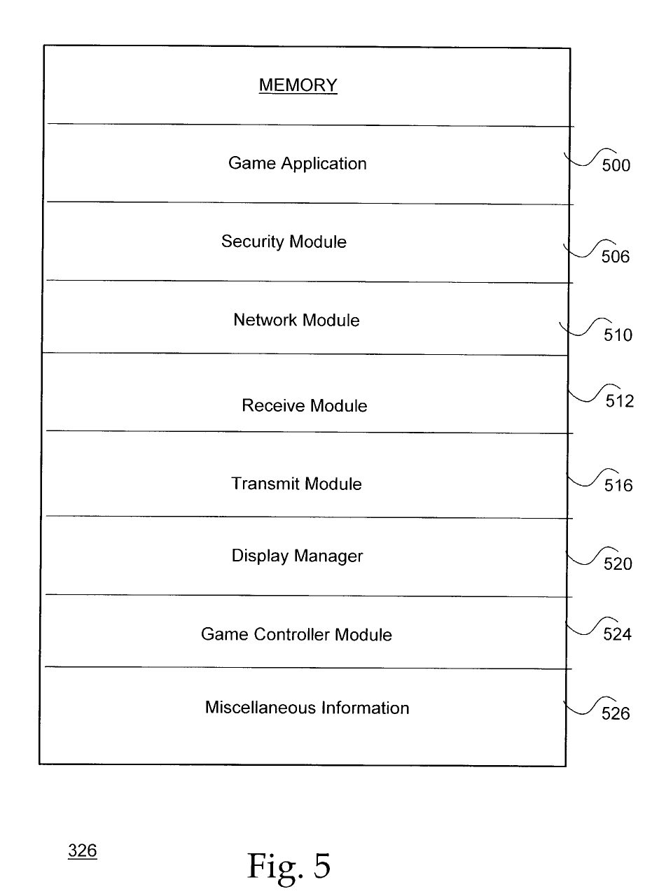

In the FIG. 3 embodiment, CPU 322 may be implemented to include any appropriate and compatible microprocessor device that preferably executes software instructions from memory 326 to thereby control and manage the operation of communications manager 218. In the FIG. 3 embodiment, memory 326 may be implemented to include any combination of desired storage devices, including, but not limited to, read-only memory (ROM), random-access memory (RAM), and various types of non-volatile memory, such as floppy disks, memory sticks, or hard disks. The contents and functionality of memory 326 are further discussed below in conjunction with FIG. 5.

In the FIG. 3 embodiment, CPU 322 may provide the A/V bitstream to DSP 330 which may then preferably process and depacketize the A/V bitstream to produce a digital video signal and a separate digital audio signal. In the FIG. 3 embodiment, DSP 330 may provide the processed digital audio signal to DAC 346 which may responsively generate a corresponding analog audio signal to speaker device 234 (FIG. 2) of portable unit 138.

In addition, in certain embodiments, DSP 330 may provide the processed digital video signal to a decoder 334 which may responsively generate a decoded digital video signal. In certain embodiments, decoder 334 may preferably upconvert the bitrate of the processed digital video signal to produce the decoded digital video signal. Decoder 334 may then preferably provide the decoded digital video signal to a graphics engine 338 for additional processing in accordance with the present invention. Graphics engine 338 may then provide the digital display signal to an audio digital-to-analog converter (DAC) 346 which may responsively generate a corresponding analog display signal to portable display 226 (FIG. 2) of portable unit 138 via path 230.

In certain embodiments, server unit 138(e) may advantageously receive various types of game control signals and other information from portable client units 138(a-d). Server unit 138(e) may then preferably provide the received game control signals to a game application to thereby allow system users to interactively participate in various gaming events. Furthermore, receive channel 314 may be utilized to receive any type of information or data in addition to, or instead of, the audio signals and video signals discussed above in conjunction with the FIG. 3 embodiment.

Referring now to FIG. 4, a block diagram for one embodiment of a transmit channel 414 from the FIG. 2 communications manager 218 is shown, in accordance with the present invention. In the FIG. 4 embodiment, transmit channel 414 may preferably include, but is not limited to, an antenna 214, a transmitter (TX) 418, a central processing unit (CPU) 322, a memory 326, a digital signal processor (DSP) 330, an encoder 434, a video analog-to-digital converter (ADC) 442, and an audio analog-to-digital converter (ADC) 446. In alternate embodiments, transmit channel 414 may readily be implemented using various components and configurations in addition to, or instead of, those discussed in conjunction with the FIG. 4 embodiment. For example, transmit channel 414 may be implemented with an encoder 434.

In the FIG. 4 embodiment, an audio source (such as a game application or other inputs 222 of FIG. 2) may preferably provide an analog audio signal to an audio analog-to-digital converter (ADC) 446 which may responsively generate a corresponding digital audio signal to DSP 330 of portable unit 138. Similarly, a video source (such as the game application or other inputs 222 of FIG. 2) may preferably provide an analog video signal to a video analog-to-digital converter (ADC) 442 which may responsively generate a corresponding digital video signal to encoder 434 of portable unit 138.

In the FIG. 4 embodiment, encoder 434 may responsively generate an encoded digital video signal from the received digital video signal from ADC 442. In certain embodiments, encoder 434 may downconvert the bitrate of the digital video signal to produce the encoded digital video signal. Encoder 434 may preferably then provide the encoded digital video signal to DSP 330 for additional processing in accordance with the present invention. In the FIG. 4 embodiment, DSP 330 may process and packetize the foregoing encoded digital video signals and the digital audio signals to produce a unified A/V bitstream. DSP 330 may then provide the A/V bitstream to CPU 332.

In the FIG. 4 embodiment, CPU 322 may be implemented to include any appropriate and compatible microprocessor device that preferably executes software instructions from memory 326 to thereby control and manage the operation of communications manager 218. In the FIG. 4 embodiment, memory 326 may be implemented to include any combination of desired storage devices, including, but not limited to, read-only memory (ROM), random-access memory (RAM), and various types of non-volatile memory, such as floppy disks, memory sticks, or hard disks. The contents and functionality of memory 326 are further discussed below in conjunction with FIG. 5. In certain embodiments, DSP 330, CPU 332, and memory 326 of FIG. 4 may be implemented by using the same components as those similarly named and numbered components from the receive channel 314 of FIG. 3, so that receive channel 314 and transmit channel 414 may economically share these components.

In the FIG. 4 embodiment, CPU 322 may preferably provide the A/V bitstream to a transmitter (TX) 418 of transmit channel 414 to generate a radio-frequency transmission of the audio/video (A/V) bitstream to server unit 138(e) via antenna 214. Transmitter 418 may preferably be implemented in any effective manner. For example, in certain embodiments, transmitter 418 may upconvert the A/V bitstream to a transmit frequency, and then may transmit the upconverted bitstream to other portable units 138

In certain embodiments, server unit 138(e) may advantageously receive various types of audio signals, video signals, and other information from client units 138(a-d). Server unit 138(e) may preferably then provide the received audio signals, video signals, and other information to the game application to thereby allow system users to participate in various gaming events. Furthermore, transmit channel 414 may be utilized to transmit any type of information or data in addition to, or instead of, the audio signals and video signals discussed above in conjunction with the FIG. 4 embodiment. For example, transmit channel 414 may transmit control signals from game controller 242 (FIG. 2).

Referring now to FIG. 5, a block diagram for one embodiment of memory 326 from FIGS. 3 and 4 is shown, in accordance with the present invention. In the FIG. 5 embodiment, memory 326 may preferably include, but is not limited to, a game application 500, a security module 506, a network module 510, a receive module 512, a transmit module 516, a window manager 520, a game controller module 524, and miscellaneous information 526. In alternate embodiments, memory 326 may readily be implemented using various components and configurations in addition to, or instead of, those discussed in conjunction with the FIG. 5 embodiment.

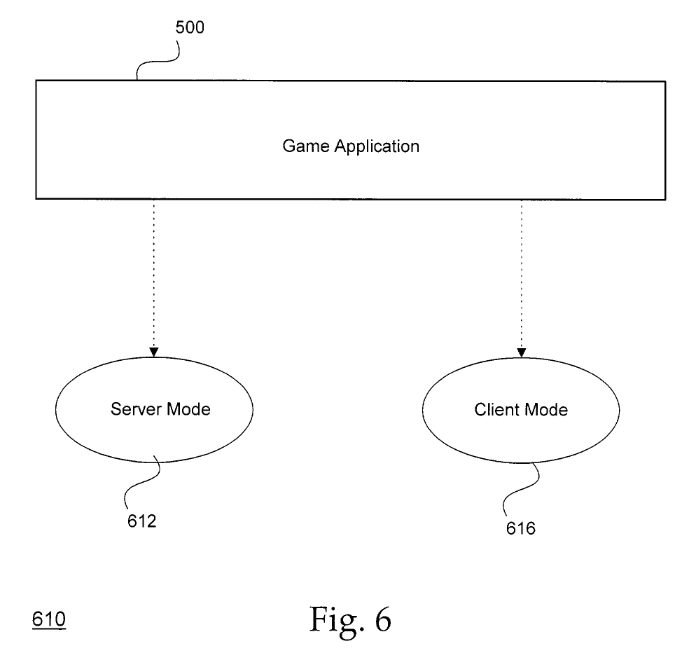

In the FIG. 5 embodiment, game application 500 may include program instructions that are preferably executed by CPU 212 (FIGS. 3 and 4) to perform various functions and operations for portable units 138. The particular nature and functionality of game application 500 preferably varies depending upon factors such as the specific type and particular use of the corresponding portable units 138. For example, game application 500 may function in either a server mode or client mode. The operation and utilization of game application 500 a server mode or client mode is further discussed below in conjunction with FIG. 6. In addition, game application 500 may preferably include game software corresponding to one or more specific games for user participation through portable units 138.

In the FIG. 5 embodiment, portable units 138 may preferably utilize security module 506 to control the participation in a particular gaming event. For example, in certain embodiments, a portable unit 138 that wishes to join a gaming event as a client unit 138(a) may preferable perform a server search procedure with receive channel 314 to wireless locate a server unit 138(e) for the gaming event. The portable unit 138 may then transmit a game access request to the security module 506 on server unit 138(e) to seek access for logging into the gaming event from server unit 138(e). In certain embodiments, the foregoing game access request may include a unit identifier, such as a unit serial number, corresponding to the portable unit 138 that seeks access to the gaming event.

In response, the security module 506 of server unit 138(e) may preferably authorize or deny access to the gaming event to the portable unit 138 by utilizing any appropriate means. For example, a system user that is the server owner/controller of server unit 138(e) may utilize security module 506 of server unit 138(e) to authorize or deny access to the portable unit 138. Alternately, security module 506 may authorize or deny the portable unit 138 based upon pre-determined criteria that may be locally stored on server unit 138(e). In certain instances, a particular portable unit 138 may be banned from further access to the gaming event.

In the FIG. 5 embodiment, network module 510 may preferably function as a base communications layer for providing simplified and user-friendly communications between various portable units 138. Network module 510 may be implemented in any suitable and effective manner. For example, network module 510 may be utilized to create and store various preset network configurations for easy recall and configuration of a particular gaming event in electronic network 110.

In the FIG. 5 embodiment, receive module 512 may include program instructions that are preferably executed by CPU 322 (FIG. 3) to perform various functions and operations for receive channel 314. The particular nature and functionality of receive module 512 preferably varies depending upon factors such as the specific type and particular functionality of the corresponding receive channel 314. Similarly, transmit module 516 may include program instructions that are preferably executed by CPU 322 (FIG. 4) to perform various functions and operations for transmit channel 414. The particular nature and functionality of transmit module 516 preferably varies depending upon factors such as the specific type and particular functionality of the corresponding transmit channel 414.

In the FIG. 5 embodiment, display manager 520 may preferably coordinate and manage various functions for generating an optimal display of a gaming event for portable units 138, in accordance with the present invention. Game controller module 524 may control and manager operations for a corresponding came controller 242 (FIG. 2). Miscellaneous information 526 may include any desired information or data required for effective functioning of portable units 138.

In the FIG. 5 embodiment, game application, 500, security module 506, network module 510, receive module 512, transmit module 516, window manager 520, and game controller module 524 are disclosed and discussed as being implemented primarily as software. However, in alternate embodiments, some or all of the functions of the present invention may be performed by appropriate electronic hardware circuits that are configured for performing various functions that are equivalent to those functions of the software modules discussed herein.

Referring now to FIG. 6, a block diagram illustrating a game application 500 with a server mode 612 and a client mode 616 is shown, in accordance with one embodiment of the present invention. In alternate embodiments, game application 500 may readily be implemented by utilizing various elements, modes, and configurations in addition to, or instead of, those discussed in conjunction with the FIG. 6 embodiment.

In the FIG. 6 embodiment, using a wireless modem (such as communication manager 218) of a handheld device such as a portable unit 138, an ad-hoc network may be set up between similar devices. As these devices may effectively be identical or at least similar, they may be allowed to accept communications from other similar devices. This would allow the playing of peer-to-peer games with more than two devices, and would not limit the gaming participants to the length of a connecting cables, but to the transmission radius of the wireless transmission system. So this gaming network could be set up anywhere, and with any compatible units.

The types of games available would be related to the performance of the processor and the display type used. To set up a network 10 to play a specific game, one wireless portable unit 138 may be designated as the server unit 138(e), and all the other wireless portable units 138(a-d) may have to log into the server unit 138(e). As each client unit 138(a-c) would have a separate serial number, it would be possible to identify a new login to a specific server unit 138(e), and then accept or decline the presence of the new device in the particular game.

Once a given portable unit 138 has been declined access, then that portable unit 138 would preferably not be able to access any portion of server unit 138(e). The server unit 138(e) may preferably have a list of the serial numbers from portable client units 138(a-d) that are currently logged in, and would be able to decline services at any time. Also settings may be made to either remember the current logged in portable units 138, or to force them to log out at the end of every game.

In accordance with the present invention, the linking up of two or more portable units 138 is therefore simple and quick. By scanning a local area in a server searching procedure, a portable unit 138 may determine whether a server unit 138(e) is active and serving games, and may then make a request to join the particular game. Security is much higher because when a new portable unit 138 tries to log onto the server unit 138(e), the server owner/controller may immediately be notified, and asked whether they wish to allow or prohibit access by the new portable unit 138.

In the FIG. 6 embodiment, a portable unit 138, such as server unit 138(e) (FIG. 1) may be set to server mode 612, which means that it oversees the game operation, and the passing of data between client units 138(a-d) that are connected to participate in a gaming event. As each connected portable unit 138 has an individual serial number, this number may be used to ensure that a particular portable unit 138 does not duplicate an existing address.

In the FIG. 6 embodiment, a client unit 138(a-d) may be a fully logged and connected handheld device that is playing in the multiplayer game. In addition, a portable unit 138 may perform a server search procedure to locate a server unit 138(e) to attach to in order to participate in the particular gaming event. Data transfer can be quite simple, in that a system user may input their name so that when the seeking portable unit 138 makes contact with the server unit 138(e), the server owner/controller may determine who the proposed player is, as well as the server hardware knowing the serial number of the proposed portable unit 138.

In certain embodiments, a portable unit 138 may be identified and for various reasons may be denied access. For example, the maximum number of players may have been reached, or the user of the new portable unit 138 may be unknown or not wanted for participation in the gaming event. This decision may be handled by the server owner/controller, and in certain embodiments may result in either a temporary or permanent barring through the unique unit identifiers.

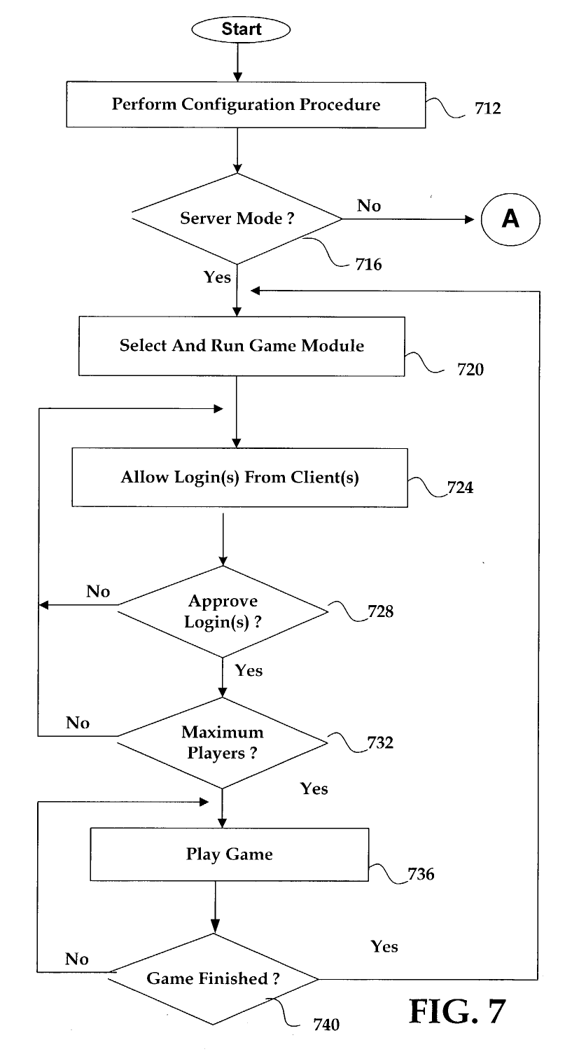

Referring now to FIG. 7, a flowchart of method steps for utilizing a portable server unit 138(e) in an electronic gaming network 110 is shown, in accordance with one embodiment of the present invention. The FIG. 7 example is presented for purposes of illustration, and in alternate embodiments, the present invention may readily utilize various steps and sequences other than those discussed in conjunction with the FIG. 7 embodiment.

In the FIG. 7 embodiment, in step 712, a system user or other appropriate entity may preferably perform a configuration procedure for setting up a corresponding portable unit 138 by utilizing any appropriate techniques. For example, in certain embodiments, the foregoing configuration procedure may specific various parameters and operating characteristics for operating the portable unit 138 in a server mode 612 as a server unit 138(e) and/or in a client mode 616 as a client unit 138(a).

The configuration procedure of step 712 may also designate configuration information to specify characteristics such as the number of participants for one or more particular gaming events, whether any portable units 138 are banned from participation in specified games, when to allow additional portable units 138 to login to a gaming event, and whether logging off is required after a particular game is concluded.

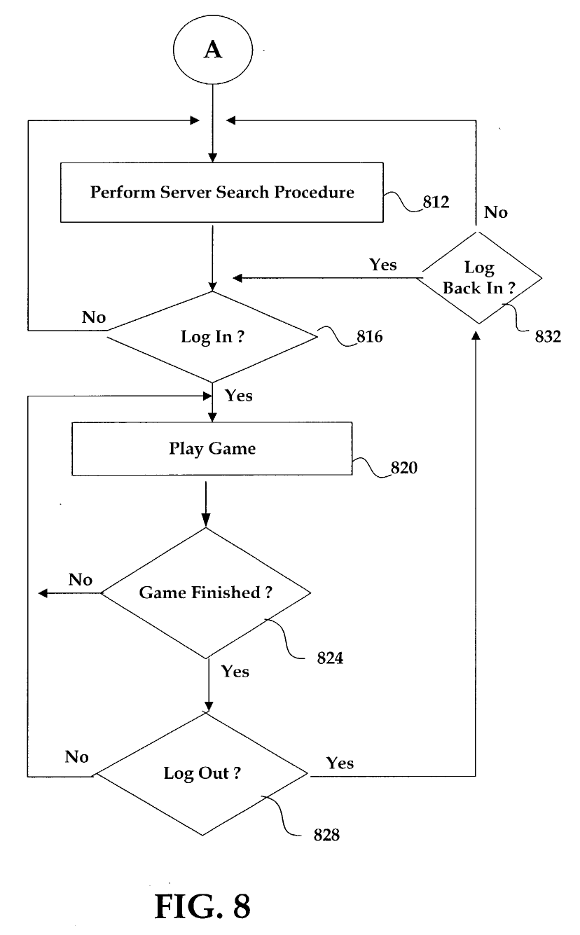

In step 716, the system user or other appropriate entity may decide whether to place the portable unit 138 into a server mode 612 or into a client mode 616. If client mode 616 is selected, then the system user or other appropriate entity may preferably instruct portable unit 138 to enter client mode 616 by utilizing any effective means such as a game controller 242, and the FIG. 7 process may then advance to letter “A” (step 812 of FIG. 8) with the portable unit 138 functioning as client unit 138(e).

However, in step 716, if server mode 612 is selected, then the system user or other appropriate entity may preferably instruct portable unit 138 to enter server mode 612 (as server unit 138(e)) by utilizing any effective means such as game controller 242. Then, in step 720, the system user or other appropriate entity may select a particular game module from a game application 500, and a CPU 322 of server unit 138(e) may preferably begin to run the game module by executing corresponding software instructions.

In step 724, a security module 506 from server unit 138(e) may preferably begin to allow one or more logins from corresponding potential game participants or clients. In step 728, the system user of server unit 138(e) or other appropriate entity may preferably approve or deny respective login attempts from the potential participants. In step 732, security module 506 may preferably determine whether a pre-determined maximum number of players corresponding to the total number of approved client logins has been reached.

In the FIG. 7 embodiment, after the designated number of game participants has been reached in step 732, then in step 736, the various system users may participate in the chosen gaming event by utilizing corresponding portable units 138. In accordance with the present invention, any of the portable units 138 may advantageously be designated as a new server unit 138(e) at any time during the course of the gaming event. For example, a current server owner/controller of a current server unit 138(e) may wish to cease participating as the server owner/controller of a particular gaming event. The FIG. 7 process may then readily return to foregoing step 716 to designate another portable unit 138 as a new server unit 138(e) to thereby resume the same or a different gaming event.

Then, in step 740, game application 500 may preferably determine whether the current game is finished. If the current game is finished, then the FIG. 7 process may preferably return to foregoing step 720, where a system user or other appropriate entity may again select and run the same or a different game module from game application 500, in accordance with the present invention.

Referring now to FIG. 8, a flowchart of method steps for utilizing a portable client unit 138(a) in an electronic gaming network 110 is shown, in accordance with one embodiment of the present invention. The FIG. 8 example is presented for purposes of illustration, and in alternate embodiments, the present invention may readily utilize various steps and sequences other than those discussed in conjunction with the FIG. 8 embodiment.

In the FIG. 8 embodiment, in step 812, the client unit 138(a) may preferably perform a server search procedure to locate a server unit 138(e) that is controlling a corresponding gaming event, as discussed above in conjunction with FIG. 7. The foregoing server search procedure may be performed in any effective manner. For example, in the FIG. 8 embodiment, client unit 138(a) may wirelessly detect server game communications from server unit 138(e), and may then responsively initiate a client login procedure by transmitting a game access request for logging into server unit 138(e), as discussed above in conjunction with FIGS. 5-7.

In step 816, client unit 138(a) may preferably determine whether the foregoing client login procedure has been successfully completed. In the FIG. 7 embodiment, if the client login procedure has been successfully completed in step 816, then in step 824, the system user of client unit 138(a) may advantageously participate in the particular gaming event. In step 840, a game application 500 from client unit 138(a) may preferably determine whether the current game is finished. In the current game is finished, then the system user of client unit 138(a) may preferably determine whether to log out from server unit 138(e).

If the system user of client unit 138(a) decides not to log out, then the FIG. 8 process may return to step 820 where client unit 138(a) may be utilized to participate in another gaming event. However, in step 828, if the system user of client unit 138(a) decides to log out, then the FIG. 8 process may preferably advance to step 832, where the system user or other appropriate entity may decide whether to log back into server unit 138(e). In step 832, if client unit 138(a) logs back in to server unit 138(e), then the FIG. 8 process may return to step 816 to perform another client login procedure. However, if client unit 138(a) does not immediately log back into server unit 138(e), then the FIG. 8 process may return to step 812, where client unit 138(a) may be utilized for subsequently performing another server search procedure.

The invention has been explained above with reference to certain embodiments. Other embodiments will be apparent to those skilled in the art in light of this disclosure. For example, the present invention may readily be implemented using configurations and techniques other than those described in the embodiments above. Additionally, the present invention may effectively be used in conjunction with systems other than those described above. Therefore, these and other variations upon the discussed embodiments are intended to be covered by the present invention, which is limited only by the appended claims.

What is claimed is:

1. A system for implementing an electronic gaming network of compatible portable units, comprising:
game applications coupled to each of said compatible portable units, said game applications being operable in a server mode and in a client mode for conducting a gaming event;
one or more client units from said compatible remote units, said one or more client units being configured to utilize corresponding ones of said game applications in said client mode to participate in said gaming event; and
a server unit from said compatible remote units, said server unit being configured to utilize one of said game applications in said server mode for managing said gaming event, said server unit utilizing a security module for separately controlling access by said one or more client units to said gaming event.

2. The system of claim 1 wherein said server unit utilizes said one of said game applications in said server mode for generating game program signals corresponding to said gaming event, said server unit processing said game program signals to produce a game program bitstream, said server unit then wirelessly transmitting said game program bitstream, said one or more client units utilizing said corresponding ones of said game applications in said client mode to receive said game program bitstream, said one or more client units each responsively processing said game program bitstream to retrieve said game program signals, said one or more client units then each generating display video signals, said one or more client units displaying said display video signals upon respective portable displays coupled to said client units.

3. The system of claim 1 wherein said compatible portable units each include an antenna, other inputs, a communications manager, a portable display, a speaker device, and a game controller that a system user utilizes to provide control signals to said server unit for interactively participating in said gaming event.

4. The system of claim 3 wherein said communications manager includes a receive channel and a transmit channel, said receive channel including said antenna, a receiver device, a central processing unit coupled to a memory device, a digital signal processor, a video decoder, a graphics engine, a video digital-to-analog converter, and an audio digital-to-analog converter, said transmit channel including an audio analog-to-digital converter, a video analog-to-digital converter, a video encoder, said digital signal processor, said central processing unit coupled to said memory device, a transmitter device, and said antenna.

5. The system of claim 1 wherein said compatible portable units each comprises a memory device that includes a dedicated one of said game applications, said security module for controlling access to said gaming event in said server mode, a network module, a receive module, a transmit module, a display module, and a game controller module.

6. The system of claim 1 wherein said server unit and said one or more client units are each configured in a substantially similar implementation that enables any of said compatible portable units to function as either said server unit or as one of said one or more client units depending upon whether said server mode or said client mode is selected.

7. The system of claim 1 wherein a system user of said server unit utilizes said server unit to participate as a player in said gaming event while simultaneously utilizing said server unit to manage said gaming event in said server mode.

8. The system of claim 8 wherein a portable unit configuration procedure is performed by system users of said compatible portable units to setup said server mode for controlling said gaming event, and to setup said client mode for participating in said gaming event.

9. The system of claim 8 wherein said portable unit configuration procedure includes specifying a maximum number of clients for said gaming event, banned portable unit identifiers, when to allow new client logins to said gaming event, and whether logoff is required after said gaming event is finished.

10. The system of claim 8 wherein said portable unit configuration procedure creates one or more pre-determined gaming configurations for said portable units, said one or more pre-determined gaming configurations being locally stored in said portable units for ready utilization by said system users.

11. The system of claim 1 wherein operating power is provided to said server unit and said one or more client units, said server unit and said one or more client units responsively activating a primary communications channel from said server unit to each of said one or more client units, said server unit and said one or more client units also activating a back communications channel from each of said one or more client units to said server unit.

12. The system of claim 11 wherein a wireless server search procedure is performed between said one or more client units and said server unit to individually request access to said gaming event from said server unit.

13. The system of claim 12 wherein said one or more client units separately detect said server unit during said wireless server search procedure, and responsively transmit corresponding game access requests to said server unit in a login procedure, said game access requests including unique portable-unit identifiers, said server unit individually authorizing or denying said game transfer requests.

14. The system of claim 13 where said server unit bans at least one of said one or more client units from accessing said gaming event by storing one or more serial numbers corresponding to said at least one of said one or more client units.

15. The system of claim 11 wherein said server unit generates an audio signal and a video signal corresponding to said gaming event, said server unit processing said audio signal and said video signal to produce a unified A/V packet stream, said server unit then wirelessly transmitting said unified A/V packet stream to said one or more client units in an identical and simultaneous manner.

16. The system of claim 15 wherein said one or more client units each receive and process said unified A/V packet stream to retrieve said audio signal and said video signal.

17. The system of claim 16 wherein said one or more client units each process said audio signal and said video signal to generate portable display signals.

18. The system of claim 17 wherein said one or more client units each present said portable display signals in a substantially full-screen manner upon a corresponding respective portable display.

19. The system of claim 1 wherein system users utilize a back communications channel to communicate with said server unit by using game controllers to thereby interactively participate in said gaming event.

20. The system of claim 1 wherein one or more client units perform logout procedures to disconnect from said server unit when said gaming event is finished, said one or more client units optionally logging back into said server unit to subsequently participate in a different gaming event.

21. A method for implementing an electronic gaming network of compatible portable units, comprising the steps of:
providing game applications to each of said compatible portable units, said game applications functioning in one of a server mode and a client mode for conducting a gaming event;
utilizing one or more client units from said compatible remote units to execute corresponding ones of said game applications in said client mode for participating in said gaming event; and
utilizing a server unit from said compatible remote units to execute one of said game applications in said server mode for managing said gaming event, said server unit including a security module for separately controlling access by said one or more client units to said gaming event.

22. The method of claim 21 wherein said server unit utilizes said one of said game applications in said server mode for generating game program signals corresponding to said gaming event, said server unit processing said game program signals to produce a game program bitstream, said server unit then wirelessly transmitting said game program bitstream, said one or more client units utilizing said corresponding ones of said game applications in said client mode to receive said game program bitstream, said one or more client units each responsively processing said game program bitstream to retrieve said game program signals, said one or more client units then each generating display video signals, said one or more client units displaying said display video signals upon respective portable displays coupled to said client units.

23. The method of claim 21 wherein said compatible portable units each include an antenna, other inputs, a communications manager, a portable display, a speaker device, and a game controller that a system user utilizes to provide control signals to said server unit for interactively participating in said gaming event.

24. The method of claim 23 wherein said communications manager includes a receive channel and a transmit channel, said receive channel including said antenna, a receiver device, a central processing unit coupled to a memory device, a digital signal processor, a video decoder, a graphics engine, a video digital-to-analog converter, and an audio digital-to-analog converter, said transmit channel including an audio analog-to-digital converter, a video analog-to-digital converter, a video encoder, said digital signal processor, said central processing unit coupled to said memory device, a transmitter device, and said antenna.

25. The method of claim 21 wherein said compatible portable units each comprises a memory device that includes a dedicated one of said game applications, said security module for controlling access to said gaming event in said server mode, a network module, a receive module, a transmit module, a display module, and a game controller module.

26. The method of claim 21 wherein said server unit and said one or more client units are each configured in a substantially similar implementation that enables any of said compatible portable units to function as either said server unit or as one of said one or more client units depending upon whether said server mode or said client mode is selected.

27. The method of claim 21 wherein a system user of said server unit utilizes said server unit to participate as a player in said gaming event while simultaneously utilizing said server unit to manage said gaming event in said server mode.

28. The method of claim 28 wherein a portable unit configuration procedure is performed by system users of said compatible portable units to setup said server mode for controlling said gaming event, and to setup said client mode for participating in said gaming event.

29. The method of claim 28 wherein said portable unit configuration procedure includes specifying a maximum number of clients for said gaming event, banned portable unit identifiers, when to allow new client logins to said gaming event, and whether logoff is required after said gaming event is finished.

30. The method of claim 28 wherein said portable unit configuration procedure creates one or more pre-determined gaming configurations for said portable units, said one or more pre-determined gaming configurations being locally stored in said portable units for ready utilization by said system users.

31. The method of claim 21 wherein operating power is provided to said server unit and said one or more client units, said server unit and said one or more client units responsively activating a primary communications channel from said server unit to each of said one or more client units, said server unit and said one or more client units also activating a back communications channel from each of said one or more client units to said server unit.

32. The method of claim 31 wherein a wireless server search procedure is performed between said one or more client units and said server unit to individually request access to said gaming event from said server unit.

33. The method of claim 32 wherein said one or more client units separately detect said server unit during said wireless server search procedure, and responsively transmit corresponding game access requests to said server unit in a login procedure, said game access requests including unique portable-unit identifiers, said server unit individually authorizing or denying said game transfer requests.

34. The method of claim 33 where said server unit bans at least one of said one or more client units from accessing said gaming event by storing one or more serial numbers corresponding to said at least one of said one or more client units.

35. The method of claim 31 wherein said server unit generates an audio signal and a video signal corresponding to said gaming event, said server unit processing said audio signal and said video signal to produce a unified A/V packet stream, said server unit then wirelessly transmitting said unified A/V packet stream to said one or more client units in an identical and simultaneous manner.

36. The method of claim 35 wherein said one or more client units each receive and process said unified A/V packet stream to retrieve said audio signal and said video signal.

37. The method of claim 36 wherein said one or more client units each process said audio signal and said video signal to generate portable display signals.

38. The method of claim 37 wherein said one or more client units each present said portable display signals in a substantially full-screen manner upon a corresponding respective portable display.

39. The method of claim 21 wherein system users utilize a back communications channel to communicate with said server unit by using game controllers to thereby interactively participate in said gaming event.

40. The method of claim 21 wherein one or more client units perform logout procedures to disconnect from said server unit when said gaming event is finished, said one or more client units optionally logging back into said server unit to subsequently participate in a different gaming event.

41. A computer-readable medium comprising program instructions for implementing an electronic gaming network of compatible portable units by performing the steps of:
providing game applications to each of said compatible portable units, said game applications functioning in one of a server mode and a client mode for conducting a gaming event;
utilizing one or more client units from said compatible remote units to execute corresponding ones of said game applications in said client mode for participating in said gaming event; and
utilizing a server unit from said compatible remote units to execute one of said game applications in said server mode for managing said gaming event, said server unit including a security module for separately controlling access by said one or more client units to said gaming event.

42. A system for implementing an electronic gaming network of compatible portable units, comprising:
means for operating said compatible portable units in one of a server mode and a client mode for conducting a gaming event;
means for utilizing said means for operating in said client mode for participating in said gaming event; and
means for executing said means for operating in said server mode for managing said gaming event, said means for executing periodically using a security module for controlling access to said gaming event by said means for utilizing.
